(19) United States
(12) Patent Application Publication
(10) Pub. No.: US 2020/0171610 A1
(43) Pub. Date: Jun. 4, 2020

(54) TOOL UNIT

(71) Applicant: JTEKT CORPORATION, Osaka-shi (JP)

(72) Inventors: Hisashi OTANI, Anjo-shi (JP); Seiji KAKAMI, Ogaki-shi (JP); Hiroyuki NAKANO, Tokai-shi (JP); Koji TOYAMA, Hekinan-shi (JP); Yuki KONNO, Kariya-shi (JP)

(73) Assignee: JTEKT CORPORATION, Osaka-shi (JP)

(21) Appl. No.: 16/697,583

(22) Filed: Nov. 27, 2019

(30) Foreign Application Priority Data
Nov. 30, 2018 (JP) 2018-225000

(51) Int. Cl. B23Q 3/12

(52) U.S. Cl. CPC B23Q 3/12

(57) ABSTRACT

A tool unit includes a rotary tool, a first holder which is connected to a first end portion of the rotary tool in an axial direction of the rotary tool, a second holder connected to a second end portion of the rotary tool in the axial direction of the rotary tool, and a third holder having a first support surface rotatably supports an outer circumferential surface of the first holder at a side of the first end portion of the rotary tool and a second support surface rotatably supports an outer circumferential surface of the second holder at a side of the second end portion of the rotary tool, the third holder being connected to the spindle housing so as not to be relatively rotatable to the spindle housing. According to this configuration, displacement of the rotary tool in the radial direction can be restricted effectively by the third unit.

### CROSS-REFERENCE TO RELATED APPLICATIONS

This application is based on and claims priority under 35 USC 119 from Japanese Patent Application No. 2018-225000 filed on Nov. 30, 2018, the contents of which are incorporated herein by reference.

### TECHNICAL FIELD

The present disclosure relates to a tool unit.

### BACKGROUND ART

When a tool holder that is connected to one end portion, in its axial direction, of a rotary tool is attached to a spindle device of a machining center, the rotary tool is cantilever-supported by the spindle device and hence sufficient rigidity of support of the rotary tool is not obtained.

As a countermeasure against the above problem, JP2001-79718A discloses a technique of both-ends-supporting a gear hob which is a rotary tool by rotatably supporting a hob shaft that is fixed to the rear end of the gear hob by an L-shaped support member that is supported by a spindle device while clamping, to the spindle device, a tool holder that is attached to the tip of the gear hob.

However, sufficient rigidity of support of the rotary tool cannot be obtained by the technique disclosed in JP2001-79718A in the case where the rotary tool is long in its axial direction.

### SUMMARY OF INVENTION

The present disclosure provides a tool unit capable of increasing the rigidity of support of a rotary tool with respect to a spindle device.

According to an aspect of the present disclosure, a tool unit configured to be provided in a machine tool including a spindle device having a spindle configured to be rotationally driven and a spindle housing configured to rotatably support the spindle, the tool unit includes a rotary tool configured to machine a workpiece, a first holder configured to be held rotatably together with the spindle, the first holder being connected to a first end portion of the rotary tool in an axial direction of the rotary tool, so as to be coaxial with and rotatable together with the rotary tool, a second holder configured to be connected to a second end portion of the rotary tool in the axial direction of the rotary tool, so as to be coaxial with and rotatable together with the rotary tool, and a third holder having a first support surface configured to rotatably support an outer circumferential surface of the first holder at a side of the first end portion of the rotary tool and a second support surface configured to rotatably support an outer circumferential surface of the second holder at a side of the second end portion of the rotary tool, the third holder being connected to the spindle housing so as not to be relatively rotatable to the spindle housing.

According to the tool unit of the present disclosure, the third holder supports the first holder which is connected to the first end portion of the rotary tool so as to be rotatable together and the second holder which is connected to the second end portion of the rotary tool so as to be rotatable together. With this configuration, the rotary tool is supported rotatably by the third holder via the first holder and the second holder. In addition, the third holder has the first support surface and the second support surface. The first support surface supports the outer circumferential surface of the first holder rotatably at a side of the first end portion of the rotary tool, and the second support surface supports the outer circumferential surface of the second holder rotatably at a side of the second end portion. With this configuration, in the tool unit, displacement of the rotary tool in the radial direction can be restricted effectively by the third unit and hence the rigidity of support of the rotary tool can be increased.

### BRIEF DESCRIPTION OF DRAWINGS

FIG. 1 is a perspective view of a machine tool according to an embodiment of the present disclosure.

FIG. 2 is a block diagram of a control device.

FIG. 3 is a front view, partially a sectional view, of a rotary tool.

FIG. 4 illustrates how the rotary tool and a workpiece operate in skiving.

FIG. 5 is a sectional view showing a state before a tool unit is attached to a spindle device; part of the tool unit is drawn in cross section.

FIG. 6 is a view showing a state that a connection pin of a clamp device is clamped in a connection hole; part of a connection portion is shown in cross section.

FIG. 7 is a view of the tool unit as viewed from a direction VII shown in FIG. 5.

FIG. 8 is a view of the tool unit as viewed from a direction VIII shown in FIG. 5.

FIG. 9 is a division diagram of the tool unit.

### DESCRIPTION OF EMBODIMENTS

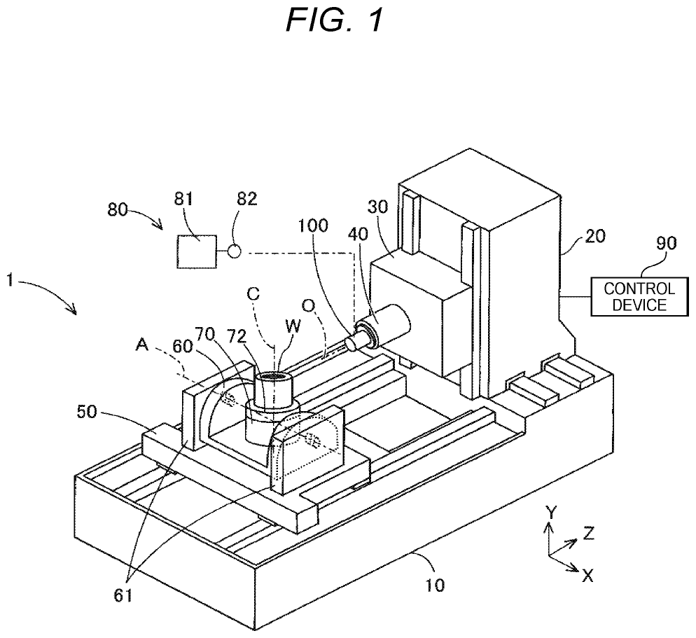

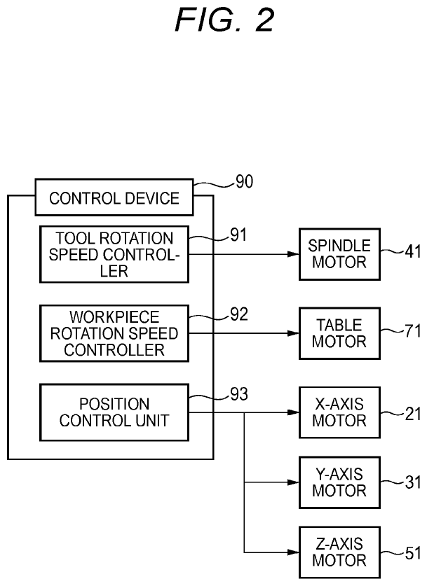

A tool unit 100 according to an embodiment of the present disclosure will be hereinafter described with reference to the drawings. First, a machine tool 1 which performs gear machining by using the tool unit 100 will be outlined with reference to FIGS. 1 and 2.

### (1. Outline of Machine Tool 1)

As shown in FIG. 1, the machine tool 1 is a machining center having, as drive axes, three orthogonal linear axes (X, Y, and Z axes) and two rotation axes (A and C axes). The machine tool 1 is mainly equipped with a bed 10, a column 20, a saddle 30, a spindle device 40, a table 50, a tilt table 60, a rotary table 70, a coolant supply device 80, and a control device 90.

The bed 10 is installed on a floor. The column 20 and an X-axis motor 21 (see FIG. 2) are provided on the top surface of the bed 10 and the column 20 is provided so as to be movable in the X-axis direction (horizontal direction) being driven by the X-axis motor 21. One side surface of the column 20 is provided with the saddle 30 and a Y-axis motor 31 (see FIG. 2) and the saddle 30 is provided so as to be movable in the Y-axis direction (vertical direction) being driven by the Y-axis motor 31. The spindle device 40 is provided so as to be rotatable being driven by a spindle motor 41 (see FIG. 2) which is housed in the saddle 30. The tool unit 100 is attached to the spindle device 40 in a detachable manner. As described later, the tool unit 100 is equipped with a rotary tool 110 for machining a workpiece W. The rotary tool 110 rotates as a spindle 42 rotates.

A table 50 and a Z-axis motor 51 (see FIG. 2) are provided on the top surface of the bed 10. The table 50 is provided so as to be movable in the Z-axis direction (horizontal direction) being driven by the Z-axis motor 51. A pair of tilt table support portions 61 which support the tilt table 60 are provided on the top surface of the table 50. The tilt table 60 is provided between the pair of tilt table support portions 61 so as to be swingable about the A-axis (extending in a horizontal direction) which is parallel with the X axis. The bottom surface of the tilt table 60 is provided with a table motor 71 (see FIG. 2), and the rotary table 70 is provided so as to be able to rotate about the C axis which is perpendicular to the A axis, being driven by the table motor 71. A holding portion 72 for holding the workpiece W is attached to the rotary table 70.

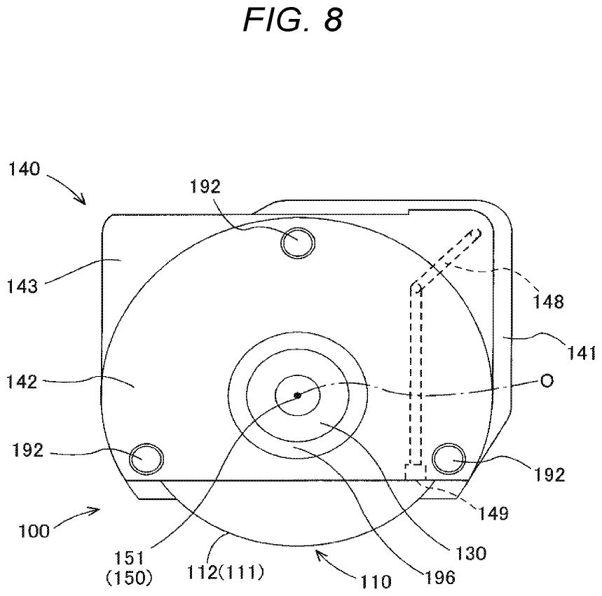

The coolant supply device 80 is mainly equipped with a coolant storage tank 81 and a pump 82 which are installed beside the bed 10. The coolant supply device 80 pumps out stored coolant from the coolant storage tank 81 by means of the pump 82, and supplies it to the tool unit 100. The tool unit 100 is integrated with a nozzle portion 148 and a nozzle outlet 149 (see FIG. 8) which discharge coolant supplied form the coolant supply device 80 toward a workpiece W working position of the rotary tool 110 (For example, the working position is a position at which the rotary tool machines the workpiece).

As shown in FIG. 2, the control device 90 performs a control relating to gear machining. The control device 90 is mainly equipped with a tool rotation speed controller 91, a workpiece rotation speed controller 92, and a position controller 93. The tool rotation speed controller 91 drive-controls the spindle motor 41 and thereby rotates the rotary tool 110 at a set rotation speed. The workpiece rotation speed controller 92 drive-controls the table motor 71 and thereby rotates the workpiece W at a set rotation speed. The position controller 93 drive-controls the X-axis motor 21, the Y-axis motor 31, and the Z-axis motor 51 and thereby positions the rotary tool 110 with respect to the workpiece W. The position controller 93 drive-controls the Z-axis motor 51 and thereby feeds the rotary tool 110 in the Z-axis direction at a set feed speed.

### (2. Rotary Tool 110)

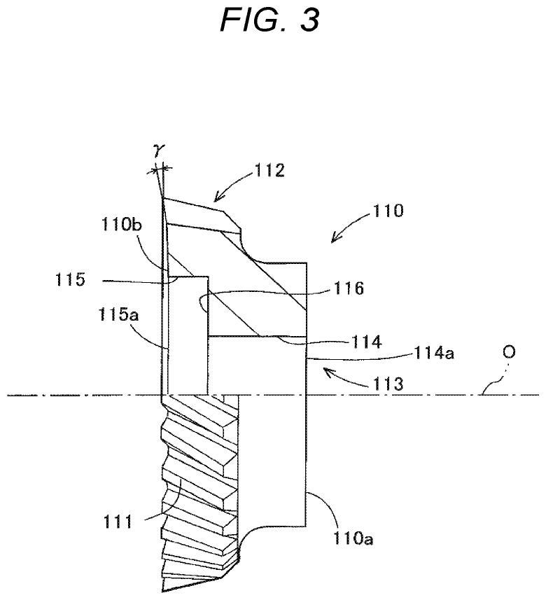

Next, the rotary tool 110 will be described with reference to FIG. 3. As shown in FIG. 3, the rotary tool 110 is a skiving cutter that is equipped with a cutter portion 112 whose outer circumferential surface has a plurality of blades 111 and the end face of each blade 111 constitutes a rake face having a rake angle γ. The rake faces of the respective blades 111 may be tapered with the axial line of the rotary tool 110 as their center or may be formed like surfaces that are directed to different directions from one blade 111 to another.

### (3. Operation of Machine Tool 1)

Next, how the machine tool 1 operates during cutting will be described. As shown in FIGS. 1-4, the machine tool 1 produces a gear in the workpiece W by skiving. The machine tool 1 inclines the C axis which is the axial line of the workpiece W with respect to a line parallel with the axial line O of the rotary tool 110 by swinging the tilt table 60 about the A axis. The inclination angle of the axial line O of the rotary tool 110 with respect to the axial line (C axis) of the workpiece W is referred to as a crossing angle δ. The machine tool 1 produces a gear by cutting the workpiece W by rotating the workpiece W and the rotary tool 110 synchronously while feeding the rotary tool 110 in the direction of its axial line O.

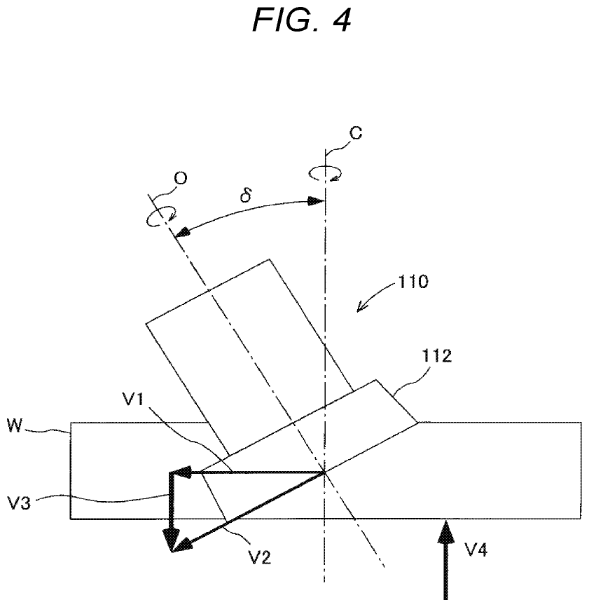

As shown in FIG. 4, in skiving, a rotation speed V1 of the workpiece W and a rotation speed V2 of the rotary tool 110 are determined by the crossing angle δ and a cutting speed V3. The cutting speed V3 and a feed speed V4 of the rotary tool 110 with respect to the workpiece W are set on the basis of a machining time (cycle time) necessary for the gear machining, specifications of the rotary tool 110, a material of the workpiece W, a twist angle of a gear to be formed in the workpiece W, and other factors. That is, the cutting speed V3 and the feed speed V4 are set at optimum speeds taking into consideration machining efficiency of the gear machining, a tool life of the rotary tool 110 or the like.

### (4. Outline of Tool Unit 100)

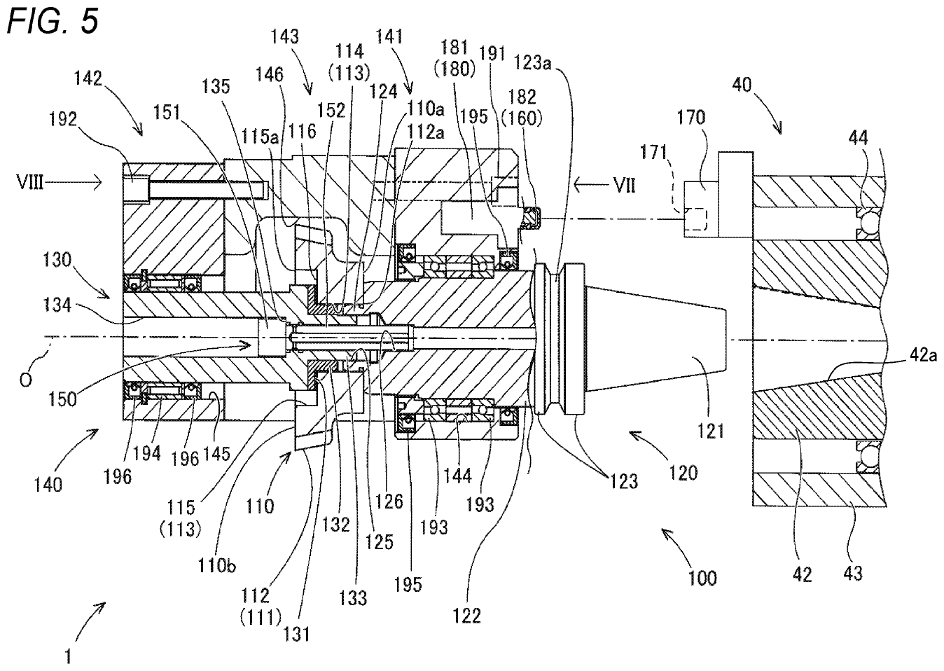

Next, the tool unit 100 will be described. First, the configuration of the tool unit 100 will be outlined with reference to FIG. 5. As shown in FIG. 5, the tool unit 100 is mainly equipped with the above-described rotary tool 110, a first holder 120, a second holder 130, and a third holder 140.

The first holder 120 is connected to a first end portion 110a (right end portion (see FIG. 5)), in the axial direction O, of the rotary tool 110 so as to be rotatable together with the rotary tool 110. The second holder 130 is connected to a second end portion 110b (left end portion (see FIG. 5), that is, an end portion opposite to the first end portion 110a), in the axial direction O, of the rotary tool 110 so as to be rotatable together with the rotary tool 110. That is, the first holder 120 and the second holder 130 rotate together with the rotary tool 110.

The third holder 140 is a member that is provided so as to surround the outer circumferential surfaces of the first holder 120 and the second holder 130. Part of the blades 111 of the rotary tool 110 project downward beyond the third holder 140. The third holder 140 is connected to the spindle device 40 so as not to be rotatable relative to it and supports the first holder 120 and the second holder 130 in such a manner that they are rotatable.

### (5. Manner of Connection of Spindle Device 40 and Tool Unit 100)

Next, a manner of connection of spindle device 40 and tool unit 100 will be described. As shown in FIG. 5, the spindle device 40 is mainly equipped with the above-mentioned spindle motor 41, the spindle 42 which is driven rotationally by the spindle motor 41, and a tubular spindle housing 43 which houses the spindle motor 41 and the spindle 42. The spindle 42 is driven rotationally by the spindle motor 41. A tip portion of the spindle 42 is formed with a taper surface 42a for chucking the first holder 120. The spindle housing 43 supports the outer circumferential surface of the spindle 42 via a ball bearing 44 so that the spindle 42 can rotate.

On the other hand, the first holder 120 is equipped with a tapered shank 121 which is to be chucked by the taper surface 42a. With the shank 121 chucked by the taper surface 42a, the first holder 120 is held by the spindle 42 so as to be rotatable together with it. Rotational drive power of the spindle motor 41 is transmitted to the rotary tool 110 via the spindle 42 and the first holder 120.

The third holder 140 is equipped with two connection pins 160 which are provided on the surface that is opposed to the spindle housing 43 when the third holder 140 is connected to the spindle housing 43. The two connection pins 160 are formed so as to project parallel with the axial direction Oof the rotary tool 110.

On the other hand, connection portions 170 having respective connection holes 171 which are formed at positions corresponding to the two connection pins 160 in such a manner that the connection pins 160 can be inserted into them, respectively, are attached to the spindle housing 43. Since the two connection pins 160 are inserted into the respective connection holes 171, the tool unit 100 is prevented from rotating relative to the spindle housing 43. The connection holes 171 may be formed in the spindle housing 43 directly.

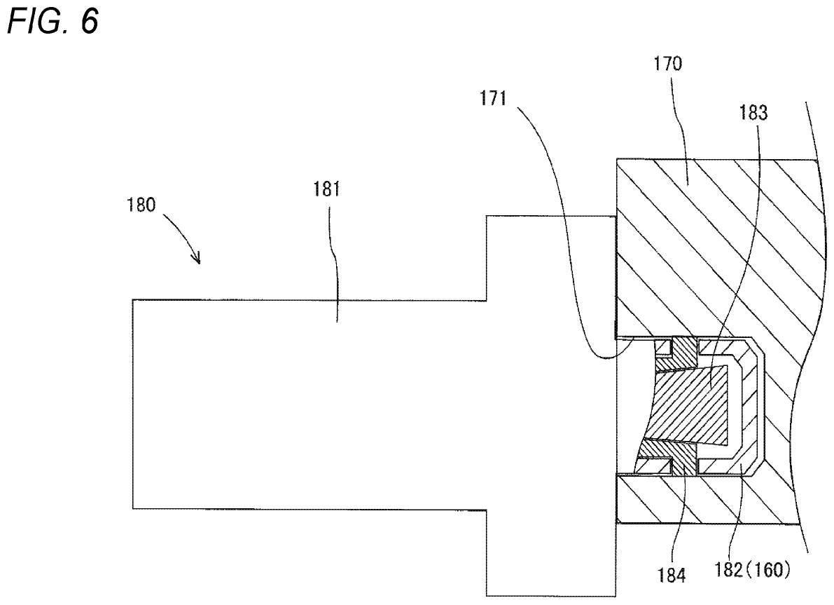

In the embodiment, a clamp device 180 which can be clamped in the corresponding connection hole 171 is provided so as to include one of the two connection pins 160. As shown in FIG. 6, the clamp device 180 is mainly equipped with a device main body 181, a pin main body 182 as the connection pin 160, a rod 183, and a clamp portion 184. The device main body 181 is housed in the third holder 140. The pin main body 182 projects from the device main body 181 toward the side of the spindle housing 43.

The rod 183 is a shaft-like member housed in the pin main body 182, and a tip portion of the rod 183 is wedge-shaped so as to increase in diameter as the position goes toward its tip side. The rod 183 is reciprocated along the axial line O direction being driven by an actuator (not shown) provided in the device main body 181. The clamp portion 184 is disposed between the outer circumferential surface of the tip portion of the rod 183 and the inner circumferential surface of the pin main body 182, and portions of the clamp portion 184 project outward in radial directions through respective holes formed through the pin main body 182.

In the clamp device 180, when the pin main body 182 as the connection pin 160 is clamped to the connection portion 170, the rod 183 is pulled into the device main body 181 side in a state that the pin main body 182 is inserted in the connection hole 171. As a result, the clamp portion 184 is pushed and expanded outward in the radial direction by the tip portion of the rod 183 which is wedge-shaped. And the portions, projecting outward in the radial directions through the pin main body 182 are pressed against the inner circumferential surface of the connection hole 171. As a result, the rod 183 is clamped to the inner circumferential surface of the connection hole 171 via the clamp portion 184 and the pin main body 182 is prevented from being dislocated along the axial line O direction relative to the connection portion 170 and the spindle housing 43.

In the above-described manner, the clamp device 180 can prevent the tool unit 100 from rotating relative to the spindle housing 43 and prevent the tool unit 100 from moving relative to the spindle housing 43 to each side along the axial line O direction. As such, the tool unit 100 can be connected to the spindle housing 43 strongly.

### (6. Details of Tool Unit 100)

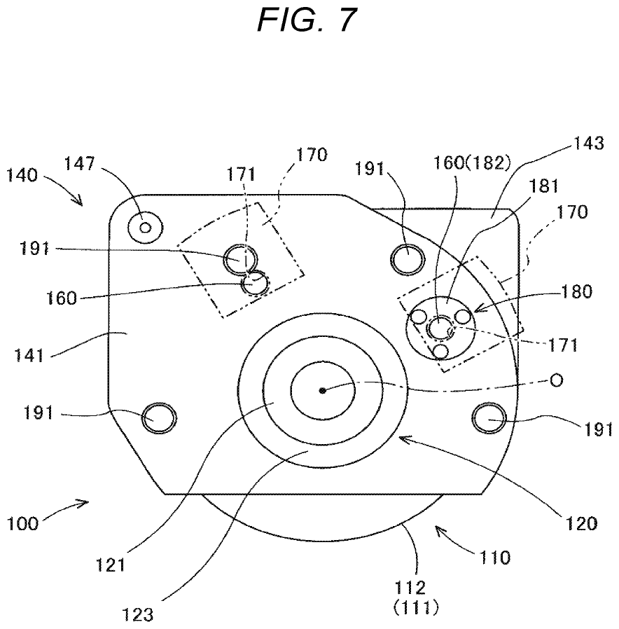

Next, individual configurations of the tool unit 100 will be described. As shown in FIG. 7, the first holder 120 is equipped with the shank 121 which is formed on the side of a first end portion, a first holder main body 122 which is formed on the side of a second end portion, and a flange portion 123 which is formed between the shank 121 and the first holder main body 122.

As described above, the shank 121 is a portion to be held by the spindle 42 (see FIG. 5) so as to be able to rotate together with it. The first holder 120 is disposed so as to be coaxial with the spindle 42 by having the shank 121 chucked by the spindle 42. The first holder main body 122 is a cylindrical portion that is connected to the first end portion 110a of the rotary tool 110. The flange portion 123 is a portion that projects outward in the radial direction beyond the shank 121 and the first holder main body 122, and is formed with a ring-shaped groove 123a which extends over the full circumference.

Incidentally, the machine tool 1 is equipped with a tool magazine (not shown) that houses a plurality of tool units 100 that can be attached to the spindle device 40 and a tool exchanging device (not shown) for exchanging a tool unit 100 attached to the spindle device 40 with a tool unit 100 housed in the tool magazine. Each tool unit 100 is housed in the tool magazine when it is not used, and is attached to the spindle device 40 by means of the tool exchanging device when it is to be used. In addition, a tool for used in a lathe machining, chamfering, boring, and the like are housed in tool magazine, and the tool or the tool unit is accordingly exchanged by means of the tool exchanging device. The tool exchanging device is equipped with an exchange arm having a hook-shaped grip portion. In attaching or detaching the tool unit 100 to or from the spindle device 40, the exchange arm grips the tool unit 100 by having its grip portion hooked on the ring-shaped groove 123a.

A description will now be made of how the rotary tool 110, the first holder 120, and the second holder 130 are connected to each other. A though-hole 113 penetrates through the rotary tool 110 in the axial line O direction. And the rotary tool 110 is formed with a fitting surface 114 which is an inner circumferential surface of the though-hole 113 and has a first opening 112a in a first end portion 110a (right end portion in FIG. 5) in the axial line O direction.

On the other hand, the second end portion side end surface of the first holder 120 is formed with a cylindrical first fitting portion 124 which is inserted into the though-hole 113 from the first opening 112a. When the first fitting portion 124 is inserted into the though-hole 113, the outer circumferential surface of the first fitting portion 124 is fitted into the fitting surface 114. As a result, in the tool unit 100, the first holder 120 is disposed so as to be coaxial with the rotary tool 110 and the rotary tool 110 is disposed so as to be coaxial with the spindle 42.

The rotary tool 110 is formed with a cylindrical surface 115 which is an inner circumferential surface of the though-hole 113 and has a second opening 115a in a second end portion 110b (left end portion in FIG. 5) in the axial line O direction. The cylindrical surface 115 is larger in diameter than the fitting surface 114 and the fitting surface 114 and the cylindrical surface 115 are connected to each other by a connection surface 116 which faces the side of the second end portion 110b, so as to form a step.

On the other hand, the first end portion side end surface of the second holder 130 is formed with a lock portion 131 to be locked on the connection surface 116 of the rotary tool 110 and a cylindrical second fitting portion 132 which projects from the lock portion 131 toward the first end portion side. The second fitting portion 132 is inserted into the though-hole 113 from the second opening 115a, whereby the outer circumferential surface of the second fitting portion 132 is fitted into the fitting surface 114 and the second holder 130 is disposed so as to be coaxial with the rotary tool 110.

The tool unit 100 is equipped with a connection bolt 150 for connecting the first holder 120 and the second holder 130 to the rotary tool 110 so that the first holder 120 and the second holder 130 can rotate together. On the other hand, the second holder 130 is formed with a bolt hole 134 through which the connection bolt 150 can be inserted. The bolt hole 134 is a through-hole that is formed so as to be coaxial with the second holder 130, and the inner circumferential surface of the bolt hole 134 is formed with a spot facing portion 135 on which a head 151 of the connection bolt 150 is locked when the connection bolt 150 is inserted from the second end portion side.

The second holder 130 is formed with a cylindrical projection 133 which projects toward the first end portion side beyond the second fitting portion 132. On the other hand, the first holder 120 is formed with a connection hole 125 having an opening in the second end portion side end surface and a female screw hole 126 which communicates with the connection hole 125. The connection hole 125 and the female screw hole 126 are formed so as to be coaxial with the first holder 120. The connection hole 125 is a hole into which the projection 133 can be inserted, and is formed through at least the first fitting portion 124. The female screw hole 126 is a hole that is smaller in diameter than the connection hole 125, and the inner circumferential surface of the female screw hole 126 is formed with a female screw to be threadedly engaged with a male screw that is formed on a shaft portion 152 of the connection bolt 150.

The connection bolt 150 is inserted into the bolt hole 134 in a state that the first fitting portion 124 and the second fitting portion 132 are inserted in the through-hole 113 and the projection 133 is inserted in the connection hole 125, and the connection bolt 150 is threadedly engaged with the female screw hole 126. At this time, the bolt hole 134 is increased in diameter being pushed outward in the radial direction by the connection bolt 150 being inserted into the bolt hole 134, whereby the second fitting portion 132 is clamped to the fitting surface 114. Furthermore, the projection 133 that is inserted in the first fitting portion 124 is pushed outward in the radial direction by the connection bolt 150 being inserted into the projection 133, whereby the first fitting portion 124 is increased in diameter and clamped to the fitting surface 114. As a result, the first holder 120 and the second holder 130 are connected to the rotary tool 110 so as to be coaxial with and rotatable together with the rotary tool 110.

The bolt hole 134 need not always be increased in diameter. For example, the first holder 120 and the second holder 130 may be connected to the rotary tool 110 so as to be coaxial with and rotatable together with the rotary tool 110 as a result of an action that the connection bolt 150 is threadedly engaged with the female hole 126 or the connection bolt 150 and the bolt hole 134 are key-connected to each other.

Next, the third holder 140 will be described. The third holder 140 is equipped with a base-side holder 141 to be connected to the spindle housing 43, a tip-side holder 142 which is disposed at a position that is more distant from the spindle device 40 than the base-side holder 141 is, and a spacer 143 which is disposed between the base-side holder 141 and the tip-side holder 142.

The base-side holder 141, the tip-side holder 142, and the spacer 143 are formed as separate bodies. The spacer 143 is connected to the base-side holder 141 by four first fixing bolts 191 so as to be rotatable together with it and is connected to the tip-side holder 142 by three second fixing bolts 192 so as to be rotatable together with it. The base-side holder 141 is provided with the above-described two connection pins 160. The third holder 140 is connected to the spindle housing 43 so as not to be rotatable relative to it because the two connection pins 160 are inserted in the connection holes 171 of the connection portions 170 which are attached to the spindle housing 43.

The two connection pins 160 which are provided in the third holder 140 are disposed above the first holder 120 (see FIG. 7). That is, the two connection pins 160 are disposed on one side. In this case, in the case where the tool unit 100 is attached to and detached from the spindle device 40 using the tool exchanging device, the exchange arm (not shown) can be prevented from interfering with the two connection pins 160 by gripping the flange portion 123 from below.

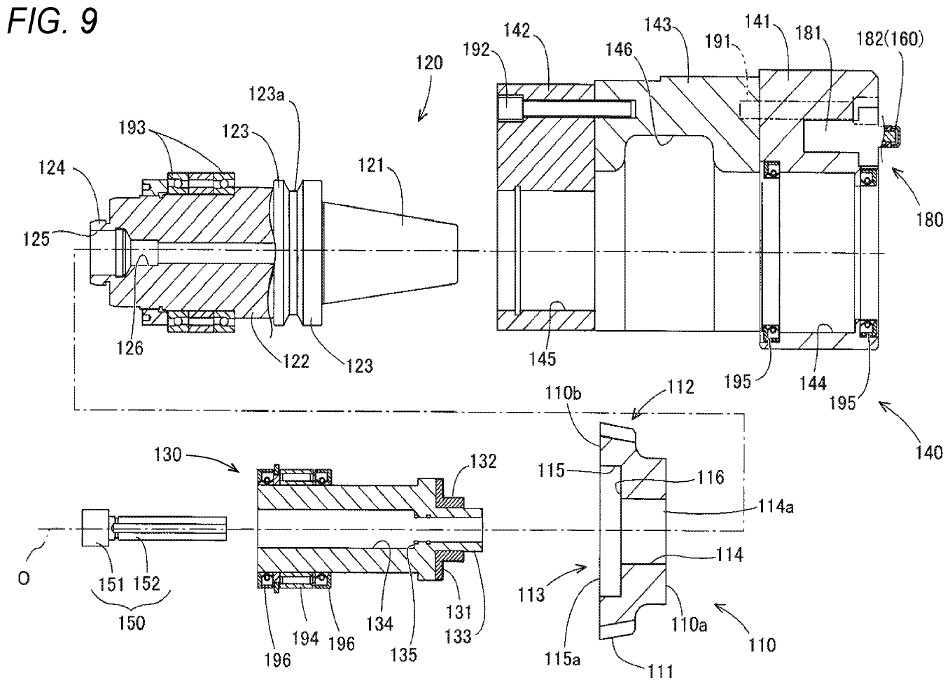

Next, individual configurations of the third holder 140 will be described. As shown in FIGS. 5-9, the base-side holder 141 has a tubular shape. The base-side holder 141 has a first support surface 144. The first support surface 144 is the inner circumferential surface of the base-side holder 141 and is located at such a position as to be opposed to the outer circumferential surface of the first holder main body 122. The first support surface 144 supports the outer circumferential surface of the first holder main body 122 rotatably via first bearings 193. Furthermore, the base-side holder 141 is provided with a coolant supply inlet 147 to which coolant is supplied from the coolant supply device 80 (see FIG. 1) at such a position as to be located outside the spindle housing 43 when the base-side holder 141 is attached to the spindle device 40.

The tip-side holder 142 has a tubular shape. The tip-side holder 142 has a second support surface 145. The second support surface 145 is the inner circumferential surface of the tip-side holder 142 and is located at such a position as to be opposed to the outer circumferential surface of the second holder 130. The second support surface 145 supports the outer circumferential surface of the second holder 130 via a second bearing 194.

The spacer 143 is a member that extends in the direction of the axial line O of the rotary tool 110. When viewed from the rotary tool 110 along the axial line O, the spacer 143 is C-shaped (open at the bottom). The spacer 143 is provided so as to surround the rotary tool 110 and part of the cutter portion 112 projects downward beyond the spacer 143. As a result, the spacer 143 can be prevented from interfering with the workpiece W when being machined by the rotary tool 110.

Since part of the cutter portion 112 projects downward beyond the base-side holder 141 and the tip-side holder 142 when the third holder 140 is viewed from outside along the axial line O, the base-side holder 141 and the tip-side holder 142 are prevented from interfering with the workpiece W when being machined by the rotary tool 110.

On the other hand, the bottom end of the spacer 143 is located below the first holder 120 and the second holder 130. Thus, the spacer 143 can suppress scattering of chips that are generated due to machining of the rotary tool 110 and coolant supplied to a working position. A pair of oil seals 195 or 196 are provided on the two respective sides, in the axial line O direction, of the first bearings 193 or the second bearing 194, whereby scattering of chips, coolant or the like to the first bearings 193 and the second bearing 194 can be prevented.

The inner circumferential surface of the spacer 143 is formed with a groove portion 146 extending in the circumferential direction at such a position as to be opposed to the cutter portion 112 of the rotary tool 110. The inner diameter of the groove portion 146 is set larger than the outer diameter of the cutter portion 112, whereby the inner circumferential surface of the spacer 143 can be prevented from interfering with the blades 111.

On the other hand, the inner diameter of the spacer 143 is set smaller than the outer diameter of the cutter portion 112 on both sides of the groove portion 146 in the axial line O direction. With this measure, the thickness of the spacer 143 in the direction perpendicular to the axial line O of the rotary tool 110 can be increased, whereby the rigidity of the third holder 140 can be increased. As a result, the rotary tool 110 can be held by the spindle device 40 strongly and hence the rigidity of support of the rotary tool 110 of the tool unit 100 can be increased.

In the third holder 140, it is possible to change the length of the spacer 143 in the axial line O direction according to the lengths of the rotary tool 110 and the first holder 120 in the axial line O direction. That is, the lengths of the rotary tool 110 and the first holder 120 in the axial line O direction have various values depending on the shape, dimensions, working position or the like of the workpiece W to be machined. Thus, the tool unit 100 needs to use a third holder 140 whose length in the axial line O direction is suitable for the lengths of a rotary tool 110 and a first holder 120 in the axial line O direction.

In this connection, in the third holder 140, the components of the base-side holder 141 and the tip-side holder 142 can be commonized by using a spacer 143 that is suitable for the lengths of a rotary tool 110 and a first holder 120 in the axial line O direction. As such, the tool unit 100 is advantageous in that the versatility of the third holder 140 is high. Furthermore, the length of the overall third holder 140 in the axial line O direction can be adjusted by changing the length, in the axial line O direction, of the spacer 143 which is simper in shape than the base-side holder 141 and the tip-side holder 142. That is, since the manufacturing cost of the spacer 143 can be made lower than that of each of the base-side holder 141 and the tip-side holder 142, the manufacturing cost of the overall third holder 140 can be lowered.

The nozzle portion 148 which communicates with the coolant supply inlet 147 is formed through the base-side holder 141, the tip-side holder 142, and the spacer 143, and the nozzle outlet 149 which communicates with the nozzle portion 148 is opened in the tip-side holder 142 so as to be directed downward. Thus, coolant that is supplied from the coolant supply device 80 flows into the nozzle portion 148 through the coolant supply inlet 147 and is discharged toward the working position from the nozzle outlet 149. In this manner, a coolant nozzle for discharging coolant supplied from the coolant supply device 80 toward the working position is integrated with the third holder 140. This makes it possible to decrease the number of components of the machine tool 1. Furthermore, the nozzle portion 148 can be cleaned efficiently by removing the tool unit 100 from the spindle device 40.

As described above, the first holder 120 is connected to the first end portion 110a of the rotary tool 110 so as to be coaxial with and rotatable together with the rotary tool 110. The third holder 140 supports, rotatably, the outer circumferential surface of the first holder 120 that is connected to the first end portion 110a of the rotary tool 110 by the first support surface 144 which is located closer to the spindle device 40 than the rotary tool 110 is.

In addition, the second holder 130 is connected to the second end portion 110b of the rotary tool 110 so as to be coaxial with and rotatable together with the rotary tool 110. The third holder 140 supports, rotatably, the outer circumferential surface of the second holder 130 which is connected to the second end portion 110b of the rotary tool 110 by the second support surface 145 which is located more distant from the spindle device 40 than the rotary tool 110 is.

As described above, the rotary tool 110 is supported rotatably on both sides of it by the third holder 140 via the first holder 120 and the second holder 130. The first support surface 144 supports, rotatably, the outer circumferential surface of the first holder 120 on the side of the first end portion 110a of the rotary tool 110 and the second support surface 145 supports, rotatably, the outer circumferential surface of the second holder 130 on the side of the second end portion 110b of the rotary tool 110. As a result, in the tool unit 100, the third holder 140 can restrict radial displacement of the rotary tool 110 effectively by means of the third holder 140, whereby the rigidity of support of the rotary tool 110 can be increased.

Furthermore, the first support surface 144 of the third holder 140 supports the first holder 120 at the position that is closer to the rotary tool 110 than the spindle 42 is. This also serves to increase the rigidity of support of the rotary tool 110. Likewise, since the second holder 130 supports the second support surface 145 with the outer circumferential surface of the second holder 130, the first holder 120 can be supported at a position that is closer to the rotary tool 110 than in a case that the second end portion side end surface of the second holder 130 is supported. Thus, the third holder 140 serves to increase the rigidity of support of the rotary tool 110.

The first bearings 193 support the outer circumferential surface of the first holder main body 122 at the position that is closer to the spindle device 40 than the rotary tool 110 is so that the first holder main body 122 is rotatable relative to the first support surface 144. And, in the tool unit 100, a pair of angular ball bearings are used as the first bearings 193. Thus, the first bearings 193 enables support for a thrust load in addition to a radial load. In particular, the tool unit 100 can be fixed to the spindle device 40 strongly because angular ball bearings are used as the first bearings 193 which are disposed at positions that are closer to the spindle device 40 than the rotary tool 110 is. As a result, with the tool unit 100, the rigidity of support of the rotary tool 110 by the spindle device 40 can be increased.

On the other hand, the second bearing 194 supports the outer circumferential surface of the second holder 130 so that the second holder 130 is rotatable relative to the second support surface 145 at the position that is more distant from the spindle device 40 than the rotary tool 110 is. And, in the tool unit 100, a radial roller bearing is used as the second bearing 194. As a result, in the tool unit 100, support for a radial load can be attained while the component cost of the second bearing 194 is lowered.

Since the rotary tool 110 is fixed to the first holder 120 and the second holder 130 by the connection bolt 150, the rotary tool 110 can be removed from the first holder 120 and the second holder 130 by cancelling the fixation by the connection bolt 150. Thus, the tool unit 100 makes it possible to switch the rotary tool 110 easily.

More specifically, in the tool unit 100, the rotary tool 110 can be removed from the first holder 120 and the second holder 130 by sliding the second holder 130 and the rotary tool 110 toward the second end portion side relative to the first holder 120 after the fixation by the connection bolt 150 is cancelled. In connection with this feature, by setting the length of the groove portion 146 in the axial line O direction longer than that of the cutter portion 112, the rotary tool 110 can be prevented from interfering with the inner circumferential surface of the spacer 143 when it is slid.

Furthermore, the first holder 120 is supported by the first support surface 144 via the first bearings 193 which are angular bearings and the second holder 130 is supported by the second support surface 145 via the second bearing which is a radial bearing. Thus, in the tool unit 100, when the rotary tool 110 is removed, the second holder 130 can be slid smoothly while sliding of the first holder 120 in the axial line O direction is prevented. As a result, workpiece of attaching or removing the rotary tool 110 can be carried out efficiently.

In particular, in the embodiment, being a skiving cutter, the rotary tool 110 is more prone to wear and higher in replacement frequency than a hob cutter. Since in the tool unit 100 workpiece of attaching or removing the rotary tool 110 can be carried out efficiently, the load of a worker can be reduced effectively.

### (7. Others)

Although the present disclosure has been described above by way of the embodiment, the present disclosure is not limited to the embodiment at all and it is understood easily that various modifications and improvements are possible without departing from the spirit and scope of the present disclosure. For example, although in the above embodiment the present disclosure is applied to the case that the rotary tool 110 is a skiving cutter, the invention can also be applied to a case that the rotary tool 110 is a hob cutter or any of other rotary tools.

Although the above embodiment is directed to the case that the first holder 120 is formed with the first fitting portion 124 and the rotary tool 110 is formed with the fitting surface 114, another embodiment may include a configuration in which the rotary tool 110 is formed with the first fitting portion 124 and the first holder 120 is formed with fitting surface 114. Although the embodiment is directed to the case that the second holder 130 is formed with the second fitting portion 132, another embodiment may include a configuration in which the rotary tool 110 is formed with the second fitting portion 132. Although the above embodiment is directed to the example that both of the first fitting portion 124 and the second fitting portion 132 are fitted with the fitting surface 114, a first fitting surface with which the first fitting portion 124 is fitted and a second fitting surface with which the second fitting portion 132 is fitted may be provide separately and the first fitting surface and the second fitting portion 132 may have different inner diameters.

Although the above embodiment is directed to the example that the tool unit 100 is provided with the connection pins 160 and the connection holes 171 are formed in the spindle device 40, another embodiment may include a configuration in which the spindle device 40 is provided with the connection pins 160 and the connection holes 171 are formed in the tool unit 100. When it suffices that at least two connection pins 160 and at least two connection holes 171 be provided, the arrangement of the connection pins 160 and the connection holes 171 and the number of clamp devices may be set in desired manners.

What is claimed is:

1. A tool unit configured to be provided in a machine tool including a spindle device having a spindle configured to be rotationally driven and a spindle housing configured to rotatably support the spindle, the tool unit comprising:
a rotary tool configured to machine a workpiece;
a first holder configured to be held rotatably together with the spindle, the first holder being connected to a first end portion of the rotary tool in an axial direction of the rotary tool, so as to be coaxial with and rotatable together with the rotary tool;
a second holder configured to be connected to a second end portion of the rotary tool in the axial direction of the rotary tool, so as to be coaxial with and rotatable together with the rotary tool; and
a third holder having a first support surface configured to rotatably support an outer circumferential surface of the first holder at a side of the first end portion of the rotary tool and a second support surface configured to rotatably support an outer circumferential surface of the second holder at a side of the second end portion of the rotary tool, the third holder being connected to the spindle housing so as not to be relatively rotatable to the spindle housing.

2. The tool unit according to claim 1, wherein one of the first end portion of the rotary tool and the first holder includes a first fitting portion that projects in the axial direction of the rotary tool,
the other of first end portion of the rotary tool and the first holder includes a first fitting surface that is fitted with an outer circumferential surface of the first fitting portion,
one of the second end portion of the rotary tool and the second holder includes a second fitting portion that projects in the axial direction of the rotary tool, and
the other of second end portion of the rotary tool and the second holder includes a second fitting surface that is fitted with an outer circumferential surface of the second fitting portion.

3. The tool unit according to claim 1, wherein the third holder comprises:
a base-side holder having a tubular shape, and being connected to the spindle housing so as not to be relatively rotatable to the spindle housing, the base-side holder including the first support surface;
a tip-side holder having a tubular shape, and being provided separately from the base-side holder, the tip-side holder including the second support surface; and
a spacer disposed between the base-side holder and the tip-side holder, and connected to the base-side holder and the tip-side holder so as to be rotatable together with each other.

4. The tool unit according to claim 1, tool unit further comprising:
an angular bearing configured to support the outer circumferential surface of the first holder such that the outer circumferential surface of the first holder is relatively rotatable to the first support surface; and
a radial bearing configured to support the outer circumferential surface of the second holder such that the outer circumferential surface of the second holder is relatively rotatable to the second support surface.

5. The tool unit according to claim 1, tool unit further comprising:
a plurality of connection pins provided in one of the third holder and the spindle housing, the plurality of the connection pins projecting from the one of the third holder and the spindle housing along the axial direction of the rotary tool; and
a plurality of connection holes provided in the other of the third holder and the spindle housing, the plurality of connection holes being formed such that the plurality of connection pins are respectively insertable into the plurality of connection holes.

6. The tool unit according to claim 5, wherein at least one of the plurality of connection pins is configured to be held with a corresponding hole of the plurality of connection holes.

7. The tool unit according to claim 1, wherein the first holder comprises a nozzle portion which is configured to discharge a coolant supplied from a coolant supply device of the machine tool toward a position at which the rotary tool machines the workpiece.

8. The tool unit according to claim 1, wherein the side of the first end portion is at a position closer to the rotary tool than the spindle device, and the side of the second end portion is at a position that is more distant from the spindle device than the rotary tool.

9. The tool unit according to claim 1, wherein the first support surface is parallel to the axial direction, and
the second support surface is parallel to the axial direction.

10. The tool unit according to claim 3, wherein an inner circumferential surface of the spacer is formed with a groove portion extending in a circumferential direction of the spacer, and
wherein the third holder supports the rotary tool which is a skiving cutter.
